(19) United States
(12) Patent Application Publication
(10) Pub. No.: US 2025/0146811 A1
(43) Pub. Date: May 8, 2025

(54) MEASURING MACHINE AND PROCESS FOR POSITIONING A WORKPIECE IN THE MEASURING MACHINE

(71) Applicant: Carl Mahr Holding GmbH, Goettingen (DE)

(72) Inventors: Nelli BEHRENS, Goettingen (DE); Markus Adam ECKHARDT, Noerten-Hardenberg (DE)

(21) Appl. No.: 18/936,193

(22) Filed: Nov. 4, 2024

(30) Foreign Application Priority Data
Nov. 7, 2023 (DE) 10 2023 130 804.1

(51) Int. Cl. G01B 11/24; G01B 11/27; G06T 7/70

(52) U.S. Cl. CPC G01B 11/24; G01B 11/272; G06T 7/70

(57) ABSTRACT

A measuring machine and a process for positioning a workpiece in the measuring machine are disclosed. A workpiece carrier holding the workpiece is driven around an axis of rotation, and an optical sensor is positioned in a measuring position parallel to the axis of rotation. In this measuring position, measuring data, such as images, are recorded on the workpiece and made available to a control unit. In the control unit, an offset and/or an inclination of a longitudinal axis of the workpiece relative to the axis of rotation is determined from the measuring data of at least two measuring points on the workpiece and then reduced or eliminated by activating a position correction system of the measuring machine such that a specified positioning condition is fulfilled. The position correction system is configured to tilt and/or translationally move the workpiece carrier relative to the axis of rotation.

### CROSS REFERENCE TO RELATED APPLICATION

This application claims the benefit of German Patent Application No. 10 2023 130 804.1, filed Nov. 7, 2023, which is incorporated herein by reference in its entirety.

### TECHNICAL FIELD

The invention relates to a measuring machine which is set up to measure a workpiece, in particular a form and/or a contour on a workpiece. The measuring machine is also set up to move the workpiece to a desired or specified position in the measuring machine before the measurement is carried out. The invention also relates to a process for positioning the workpiece in the measuring machine prior to measurement.

### BACKGROUND

This type of measuring machine and process are known, for example, from EP 3 255 378 A1. Here, a contactless or tactile sensor is used to measure a profile or scan of a workpiece surface in different rotational positions along a measuring plane defined in a machine coordinate system. This can then be used to determine an inclination and an offset of a longitudinal axis of the workpiece in relation to an axis of rotation of the measuring machine.

DE 10 2019 120 553 A1 discloses a device and a process for measuring the roundness of a workpiece. The workpiece can be placed on a workpiece carrier and initially moved to a desired position. For this purpose, the workpiece is recorded by a video camera and displayed to an operator. The display helps the operator to place the workpiece on the workpiece carrier. As part of this, the workpiece can also be automatically positioned and aligned on the workpiece carrier based on the video recording. The video camera is part of a system available separately from the measuring machine.

An inductive rotary transmitter for the wireless transmission of electrical energy is known from DE 10 2015 100 233 A1.

### SUMMARY

Based on the prior art, one object of the present invention is considered to be to create a measuring machine and a process that enables both fast and very precise positioning of the workpiece in the measuring machine.

This object is met by a measuring machine with the features described herein.

The measuring machine is set up to measure a form and/or a contour on a workpiece. It has a workpiece carrier on which the workpiece can be placed. For this purpose, the workpiece carrier can have a clamping device, such as a chuck with several clamping jaws or a holding mandrel that interacts with a counter-holding mandrel, with the workpiece being held between the holding mandrel and the counter-holding mandrel. The workpiece carrier can also have a surface for placing or supporting the workpiece on an underside of the workpiece.

The measuring machine is set up in particular for measuring workpieces that are rotationally symmetrical to a longitudinal axis of the workpiece. However, depending on the measuring task, it may also be possible to measure workpieces that are not rotationally symmetrical to a longitudinal axis of the workpiece and have an outer thread or outer helical gearing, for example.

The measuring machine has a rotating drive, by means of which the workpiece carrier can be rotationally driven around an axis of rotation of the machine, for example continuously at a constant speed. An optical sensor is assigned to the workpiece carrier. The detection range of the optical sensor is directed towards a working area, in which at least one section of the workpiece is located when it is placed on the workpiece carrier.

A sensor-positioning device of the measuring machine is set up to move the optical sensor parallel to the machine's axis of rotation to a desired measuring position and to position it there. The sensor positioning device can be used to position the optical sensor at one or more suitable measuring positions in order to record measuring data on the workpiece.

In particular, only one contour of a longitudinal section of the workpiece is positioned in the detection range of the optical sensor in each measuring position and not the complete workpiece or a complete contour shape parallel to the longitudinal axis of the workpiece.

The measuring machine also has a position correction system that is used to tilt and/or translationally move the workpiece carrier relative to the machine's axis of rotation. This allows the longitudinal axis of the workpiece to be aligned and positioned as desired in relation to the machine's axis of rotation.

The measuring machine has a control unit that controls the operation of the measuring machine. The control unit can perform or initiate the following steps to position the workpiece in the measuring machine:

The control unit controls the rotating drive in such a way that the workpiece carrier rotates around the machine's axis of rotation. A workpiece placed on the workpiece carrier also rotates around the machine's axis of rotation. Beforehand, or at the same time, the optical sensor is moved to a desired measuring position using the sensor positioning device. In this measuring position, measuring data is then recorded on a contour of the workpiece and provided by the optical sensor for the control unit while the workpiece rotates around the machine's axis of rotation. In one single measuring position of the optical sensor, the measuring data is recorded in particular only on a longitudinal contour section of the workpiece, which is only a section or subarea of the entire workpiece contour extending parallel to the longitudinal axis of the workpiece.

The control unit is set up to determine an offset and/or an inclination of a longitudinal axis of the workpiece relative to the machine's axis of rotation based on the measuring data. The determined offset and/or the determined inclination represent a position deviation of the longitudinal axis of the workpiece relative to the machine's axis of rotation. The position deviation is set by means of the position correction system while the workpiece continues to rotate around the machine's axis of rotation in such a way that the offset and/or the inclination fulfill(s) a predetermined positioning condition.

It is preferable if the position correction system defines a reference plane that is aligned at right angles to the machine's axis of rotation, for example. The offset is determined in this reference plane. At least one measuring position of the optical sensor is parallel to the machine's axis of rotation at a distance from the reference plane. The reference plane is preferably a plane that is neutral to the inclination of the workpiece carrier set by the position correction system. In particular, the offset determined in the reference plane may be independent of the inclination of the workpiece carrier or the longitudinal axis of the workpiece relative to the machine's axis of rotation.

For example, the measuring machine can be used to achieve fast and good positioning of the workpiece in the measuring machine in one single measuring position of the optical sensor. To increase the positioning accuracy, it is also possible to place the optical sensor in two measuring positions parallel to the machine's axis of rotation at a distance from each other and to record measuring data in both measuring positions. This makes it possible to determine the offset and/or inclination (i.e. the position deviation) of the longitudinal axis of the workpiece relative to the machine's axis of rotation more accurately and to position the workpiece more precisely. Regardless of the number of measuring positions at which measuring data is recorded, the rotating drive can continuously rotate the workpiece carrier or the workpiece placed on it around the machine's axis of rotation, eliminating the need to stop and restart the rotational movement.

Preferably, the optical sensor should be a camera, in particular a line scanning or matrix camera. When using a matrix camera, measurements can be taken at several measuring points on the contour of the workpiece in a single measuring position of the matrix camera. When using a camera, the measuring data is provided in the form of at least one image of a contour (in particular just a longitudinal section of the contour) of the workpiece, which is recorded at one or more measuring positions.

It is advantageous if the measuring machine has a buffer memory that a communicatively connected to the optical sensor and, in particular, the camera. The buffer memory is used to temporarily store measuring data, in particular images, which can then be made available to the control unit. This means that the measuring data can be recorded by the optical sensor regardless of the processing speed of the measuring data or images in the control unit.

The buffer memory can be part of the control unit or designed as a separate data memory. In either case, the buffer memory is communicatively connected to the control unit or a computing device of the control unit.

To check the positioning condition, the control unit can prompt the optical sensor to record and provide measuring data again at the—preferably unchanged—measuring position. The measuring data provided can then be compared with reference data. The reference data can, for example, contain one or more limit values. The comparison result indicates whether the positioning condition is fulfilled or not. For example, the measuring data can be used to detect a position deviation between the longitudinal axis of the workpiece and the machine's axis of rotation at one or more measuring positions on the contour of the workpiece, and to check whether this position deviation is less than at least one specified limit value.

When checking the positioning condition, measuring data can be recorded at a single measuring position of the optical sensor in an exemplary embodiment. Preferably, the optical sensor should be set up to record measuring data at several measuring positions on the contour of the workpiece. In particular, the measuring positions are parallel to the machine's axis of rotation at a distance from each other on the contour of the workpiece.

In a further exemplary embodiment, the optical sensor is placed in at least two different measuring positions as part of the positioning condition check, and measuring data is recorded on the contour of the workpiece in each measuring position. In this exemplary embodiment, the accuracy in determining the position deviation between the longitudinal axis of the workpiece and the machine's axis of rotation can be increased and the workpiece can be positioned more precisely in the measuring machine. The measuring positions are spaced parallel to the machine's axis of rotation. The measuring positions should be preferably the same, at right angles to the machine's axis of rotation. To move the optical sensor between the measuring positions, preferably movement should only be made parallel to the machine's axis of rotation.

The distance between two measuring positions parallel to the machine's axis of rotation is, for example, at least 10% or at least 25% or at least 50% of the length of the workpiece parallel to the longitudinal axis of the workpiece.

It is particularly advantageous if the workpiece is positioned in the measuring machine in a multi-step and, in particular, two-step process. First, the optical sensor is moved to an initial measuring position, where measuring data is recorded on the contour of the workpiece. The control unit then checks whether a first positioning condition based on first reference data (e.g. first limit values) is fulfilled. If necessary, the position of the longitudinal axis of the workpiece is corrected by the position correction system until the first positioning condition is fulfilled. For this check, the optical sensor remains in the first measuring position and provides measuring data for inspection. Once the first positioning condition has been fulfilled, the optical sensor can be moved to a second measuring position by means of the sensor positioning device and record measuring data on the contour of the workpiece there. Measuring data is then available from the first and second measuring position, which was recorded after the first test condition was met. This measuring data is then used to check whether a second positioning condition based on second reference data is fulfilled. The second reference data (e.g. second limit values) on which the second positioning condition is based can differ from the first reference data (e.g. first limit values) and, in particular, allow a smaller position deviation of the longitudinal axis of the workpiece from the machine's axis of rotation than the first positioning condition based on the first reference data.

In a preferred embodiment, the communication connection between the control unit and the position correction system can be wireless. The position correction system can also receive electrical energy wirelessly, for example by means of inductive energy transmission.

Any exemplary embodiment of the above-described measuring machine can be used to perform a process of positioning a workpiece in the measuring machine.

### BRIEF DESCRIPTION OF THE DRAWINGS

Advantageous configurations of the invention can be found in the dependent claims, the description and the drawing. Preferred exemplary embodiments of the invention are explained below in detail based on the attached drawing. The following is shown in the drawing:

FIG. 1 is a block diagram of an exemplary embodiment of a measuring machine,

FIG. 2 is a highly schematized representation of essential components of the measuring machine from FIG. 1 in the form of a block diagram to explain its function,

FIG. 3 shows the alignment of a longitudinal axis of a workpiece parallel to an axis of rotation of the measuring machine from FIGS. 1 and 2 by means of a position correction system of the measuring machine and

FIG. 4 shows the translational movement of the workpiece by means of the position correction system of the measuring machine to reduce or eliminate an offset between the longitudinal axis of the workpiece and the machine's axis of rotation,

FIG. 5 is a flow chart of an exemplary embodiment of a process according to the invention and

FIGS. 6a and 6b are a flow chart of a further exemplary embodiment of a process according to the invention.

### DETAILED DESCRIPTION

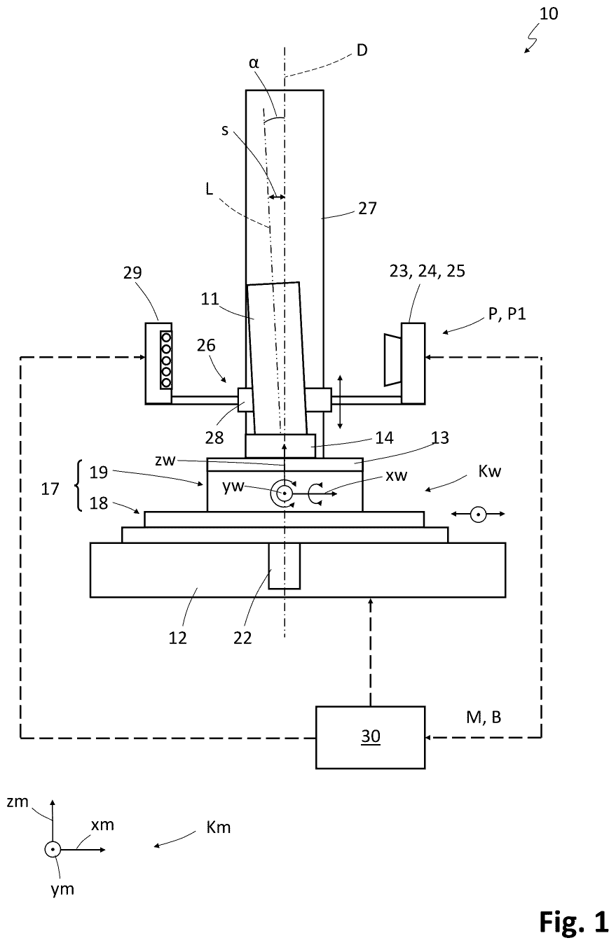

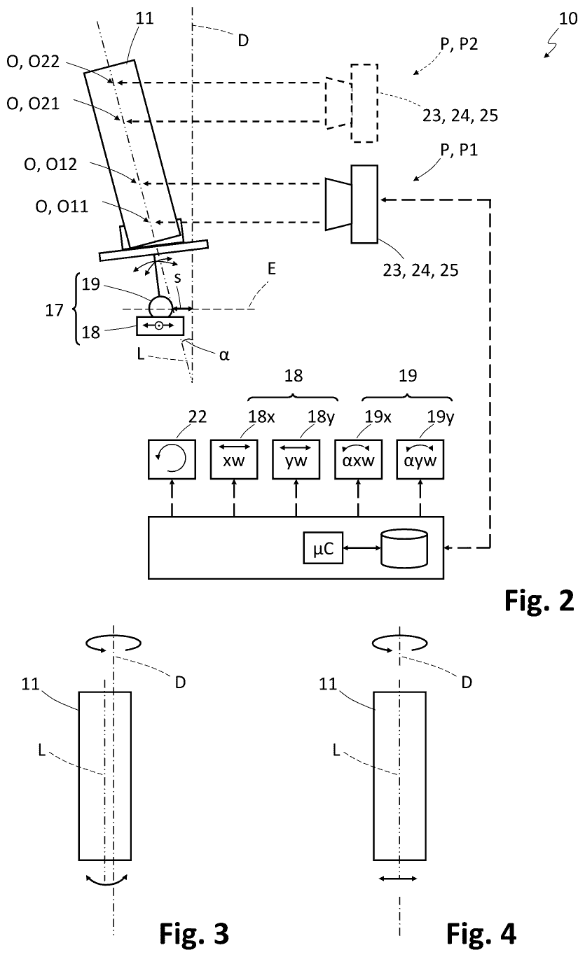

FIG. 1 shows a block diagram as an exemplary embodiment of a measuring machine 10. The block diagram in FIG. 2 only shows parts of the measuring machine 10 that are essential for explaining the functional principle of the measuring machine 10 and a process V1, V2 that can be carried out using the measuring machine 10.

The measuring machine 10 is set up to measure a form and/or a contour of a workpiece 11. It has a machine base 12, on which a workpiece carrier 13 is placed. In the exemplary embodiment, the workpiece carrier 13 is designed in the form of a table. The workpiece carrier 13 is used to position the workpiece 11 in the measuring machine 10. For this purpose, suitable support or clamping devices 14 can be placed on the workpiece carrier 13 or connected directly or indirectly to the workpiece carrier 13. The clamping device 14 can be a chuck, for example.

There is a machine coordinate system Km defined as immovable relative to the machine base 12. This may, for example, be a Cartesian coordinate system with a first coordinate axis xm, a second coordinate axis ym and a third coordinate axis zm. A position correction coordinate system Kw is defined as immovable relative to the workpiece carrier 13 or the workpiece 11 placed on the workpiece carrier 13, which may, for example, be a Cartesian coordinate system with a first coordinate axis xw, a second coordinate axis yw and a third coordinate axis zw.

The workpiece carrier 13 is indirectly connected to the machine base 12 via a position correction system 17. The position correction system 17 is set up to change or set the position of the workpiece carrier 13 relative to the machine base 12. For this purpose, the position correction system 17 can tilt the workpiece carrier 13 around the first and second coordinate axis xw, yw of the position correction coordinate system Kw. The first and second coordinate axis xw, yw of the position correction coordinate system Kw are aligned at right angles to each other, for example within a plane which, in an ideal positioning of the workpiece 11 on the workpiece carrier 13, is aligned at right angles to the longitudinal axis L of the workpiece. In this case, the third coordinate axis zw of the position correction coordinate system Kw would extend parallel to the longitudinal axis L of the workpiece or congruently along the longitudinal axis L of the workpiece. When the workpiece 11 is not ideally aligned, the third coordinate axis zw of the position correction coordinate system Kw and the longitudinal axis L of the workpiece are inclined at an acute angle to each other.

The position correction system 17 has a linear drive system 18, by means of which the workpiece carrier 13 can be moved translationally, for example towards the first coordinate axis xw and the second coordinate axis yw of the position correction coordinate system Kw. For this purpose, the linear drive system 18 has a first linear drive 18x for the translational movement towards the first coordinate axis xw of the position correction coordinate system Kw and a second linear drive 18y for the translational movement of the workpiece carrier 13 towards the second coordinate axis yw of the position correction coordinate system Kw.

The position correction system 17 also has a tilting drive system 19 to tilt or incline the workpiece carrier 13 relative to the machine coordinate system Km. In the exemplary embodiment, the tilting drive system has a first tilting drive 19x for a tilting movement around the first coordinate axis xw of the position correction coordinate system Kw and a second tilting drive 19y for a tilting movement around the second coordinate axis yw of the position correction coordinate system Kw. To tilt the workpiece carrier 13, the tilting drives 19x, 19y can, for example, set the distance of the workpiece carrier 13 from the machine base 12 differently at different points, which then results in the skew or inclination of the workpiece carrier 13. For example, adjustable wedge surfaces can be used for this purpose, on which the workpiece carrier 13 is supported at an assigned point.

The measuring machine 10 also has a rotating drive 22, which is set up to drive the workpiece carrier 13 in rotation around an axis of rotation of the machine D. In the exemplary embodiment illustrated here, the machine's axis of rotation D is aligned parallel to the coordinate axis zm of the machine coordinate system Km. Rotating drive 22 can, for example, be placed on the machine base 12 and drive the position correction system 17 together with the workpiece carrier 13 in rotation around the machine's axis of rotation D. When a workpiece 11 is placed on the workpiece carrier 13, the workpiece 11 is driven in rotation together with the workpiece carrier 13 around the machine's axis of rotation D.

The measuring machine 10 has an optical sensor 23 for measuring data M on the workpiece 11 and in particular on a contour of the workpiece 11. The optical sensor 23 used in the exemplary embodiment is a camera 24 and in particular a matrix camera 25.

By means of a sensor positioning device 26, the optical sensor 23 can be arranged parallel to the machine's axis of rotation D in a desired measuring position P; a first measuring position P1 and a second measuring position P2 are shown schematically as examples in FIG. 2. The sensor positioning device 26 can, for example, have a slide 28 that can be moved along a column 27. The column 27 can be arranged on the machine base 12. The optical sensor 23 is connected to the slide 28 using a suitable support device.

In the exemplary embodiment, a lighting device 29 is optionally provided in order to emit light towards the working area of the measuring machine 10 or of a workpiece 11 positioned on the workpiece carrier 13. The lighting device 29 is particularly advantageous if a camera 24 (e.g. matrix camera 25) is used as the optical sensor 23. The camera 24 and the lighting device 29 are arranged on opposite sides or opposite each other with regard to the workpiece 11 or with regard to the machine's axis of rotation D. The lighting device 29 emits light towards the camera 24. The light can be partially shadowed by the workpiece 11 in such a way that the light detected by the camera 24 and emitted by the lighting device 29 can map the contour of at least one section of the workpiece 11. The camera 24 and the lighting device 29 are thus designed as a transmitted light system.

The lighting device 29 can be moved together with the camera 24 by means of the sensor positioning device 26. In addition to the translational movement parallel to the machine's axis of rotation D, the sensor positioning device 26 can also be set up to swivel the optical sensor 23 and, for example, the camera 24 around an axis which is aligned at right angles to the machine's axis of rotation D. This can be advantageous, for example, when measuring helical workpiece contours such as threads.

As can also be seen schematically in FIGS. 1 and 2, the measuring machine 10 has a control unit 30. The control unit 30 is communicatively connected to the optical sensor 23, the sensor positioning device 26, the rotating drive 22 and the position correction system 17. The communication connections can be wired and/or wireless. In particular, the communication connection to the position correction system 17 can be wireless, since the position correction system 17 can be rotated around the machine's axis of rotation D together with the workpiece carrier 13.

In the exemplary embodiment illustrated in FIG. 1, the control unit 30 is also communicatively connected to the lighting device 29, if a lighting device 29 is present. Alternatively, this communication connection can be omitted and the optical sensor 23 can be communicatively connected to the control unit of the lighting device 29 to control it.

The control unit 30 has a computing device 31, for example a microcontroller. In a preferred exemplary embodiment, the control unit 30 is communicatively connected to a buffer memory 32 (FIG. 2). In particular, there is a communication connection between the computing device 31 and the buffer memory 32. In the exemplary embodiment shown in FIG. 2, the buffer memory 32 is part of the control unit 30. Alternatively, the buffer memory 32 can also be designed as a data memory separate from the control unit 30.

The optical sensor 23 can record measuring data M of a contour on the workpiece 11 in each measuring position P and provide it to the control unit 30. When configured as camera 24, images B taken by the camera 24 represent the measuring data M.

If the camera 24 has several pixel elements, as is the case with the matrix camera 25, measurements can be taken at several measuring points O on the workpiece 11 in each measuring position P, for example at a first measuring point O11 and at a second measuring point O12 in the first measuring position P1 and at a first measuring point O21 and a second measuring point O22 in the second measuring position P2 (FIG. 2). At each measuring position P1, P2, the measuring points O11, O12 or O21, O22 that can be detected there are arranged at a distance from each other towards the machine's axis of rotation D.

With matrix camera 25, the pixel elements are arranged and aligned parallel to a zm-ym plane of the machine coordinate system Km. This zm-ym plane is defined by the second coordinate axis ym and the third coordinate axis zm of the machine coordinate system Km.

The measuring data M can therefore represent coordinate values determined from the images B in the directions xm, ym, zm and D, for example. In the transmitted light method, the light-dark transition in one row describes the position of the workpiece in the machine coordinate system Km. The camera pixels are assigned coordinate values zm, ym and xm of the machine coordinate system Km, with the position of the light/dark transition being determined in consideration of the sensor positioning device 26. The sensor positioning device 26 can position the optical sensor 23 (here: camera 24) along one spatial direction or also by means of several (e.g. combined or stacked) positioning axes of the measuring machine 10 in several spatial directions. In addition, the corresponding coordinate value of the rotating position of the machine's axis of rotation D and thus the corresponding workpiece rotational position is recorded for each image B.

When a workpiece 11 is placed on the workpiece carrier 13, a longitudinal axis L of the workpiece 11 can have a position deviation relative to the machine's axis of rotation D. If the rotating drive 22 causes a rotation around the machine's axis of rotation D, the workpiece 11 performs an eccentric rotational movement around the machine's axis of rotation D. The eccentricity depends on an offset s and an inclination α of the longitudinal axis L of the workpiece relative to the machine's axis of rotation D.

The inclination α can have inclination angle components in several directions, for example an inclination angle component in the plane spanned by the first coordinate axis xm and the third coordinate axis zm of the machine coordinate system Km and an inclination angle component spanned by the second coordinate axis ym and the third coordinate axis zm of the machine coordinate system Km.

In addition or as an alternative to the inclination α, the longitudinal axis L of the workpiece can have an offset s in a direction at right angles to the machine's axis of rotation D. As with the inclination α, the offset s can have several offset components, for example an offset component in a plane spanned by the first coordinate axis xm and the third coordinate axis zm of the machine coordinate system Km and an offset component in a plane spanned by the second coordinate axis ym and the third coordinate axis zm in the machine coordinate system Km.

This means that the inclination α and the offset s can be two-dimensional vectors, so to speak.

The offset s is determined by the control unit 30 in a reference plane E, for example, which is defined by the design of the position correction system 17 (FIG. 2). In this reference plane E, the inclination setting of the workpiece carrier 13 around the first and second coordinate axes xw, yw of the position correction coordinate system Kw does not affect any offset s between the machine's axis of rotation D and the longitudinal axis L of the workpiece. The reference plane E can be described as a tilt-neutral plane. It is preferably positioned outside the working area of the measuring machine 10, in which a workpiece 11 is located, which is held on the workpiece carrier 13.

The position of the reference plane E can, for example, be determined from the design data of the position correction system 17 and stored as a position value relative to the machine coordinate system Km (e.g. position of the reference plane parallel to the third coordinate axis zm).

It is particularly advantageous to calibrate and store the exact position of the reference plane E once after manufacture or final assembly of the measuring machine 10. A known workpiece or standard can be measured in one or more measuring positions P, P1, P2. Correction values for the drives of the position correction system 17 can then be determined and set assuming a theoretical original value for the position of the reference plane E, e.g. determined on the basis of the design data. Subsequent measurement in P1 and P2 and determination of the offset s and the inclination α that are still present enables the actual position of the reference plane E for the individual measuring machine 10 to be determined by means of a nominal/actual comparison. This two-stage procedure for determining the position of the reference plane E can be carried out once or several times, in particular iteratively. The position of the reference plane E determined after the first run can be used as a theoretical starting value for the position of the reference plane E in the next process cycle.

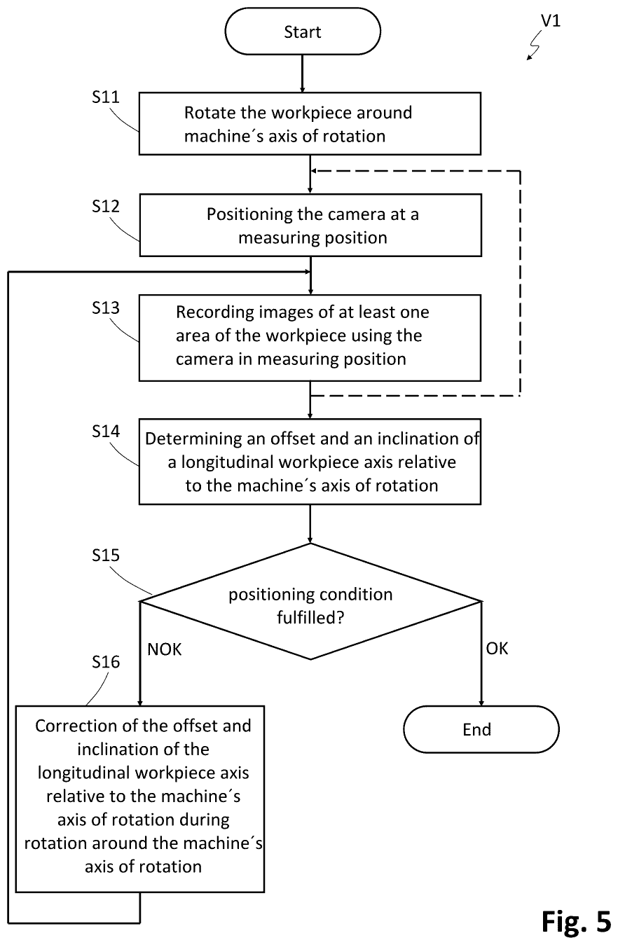

In order to reduce or eliminate any offset s and/or any inclination α that may be present after the workpiece 11 has been positioned on the workpiece carrier 13, the measuring machine 10 can perform a process for positioning or correcting the position of the workpiece 11, controlled by the control unit 30. FIG. 5 shows an exemplary embodiment of the process in the form of a flow chart, which can be referred to as the first process V1.

After the start of the first process V1, the control unit 30 prompts the workpiece 11 to rotate around the machine's axis of rotation D (first step S11 of the first process V1) by activating the rotating drive 22. In a second step S12 of the first process V1, the camera 24 is placed at a measuring position P. For this purpose, the control unit 30 can, if necessary, control the sensor positioning device 26 if the camera 24 is not yet in the desired measuring position P. The second step S12 can be carried out at the same time as or before the first step S11.

The measuring position P has a determinable distance to the reference plane E, which can be measured, for example, by sensors using suitable position sensors of the sensor positioning device 26.

While the workpiece 11 is rotated around the machine's axis of rotation D, the camera 24 records images B in the measuring position P (third step S13 of the first process V1), with two or more measuring points O being recorded in each image, for example, which are arranged parallel to the machine's axis of rotation D at a distance from one another. As an example, the first measuring point O11 and the second measuring point O12 are shown schematically in the first measuring position P1, and the first measuring point O21 and the second measuring point O22 are shown schematically in the second measuring position P2 in FIG. 2.

Alternatively, the camera can also only detect a single measuring point in each measuring position P and is moved accordingly to several measuring positions to measure at several measuring points.

A circular profile (in particular a contour in the circumferential direction) can be recorded at each measuring point and its center point or center of gravity determined. Two center points arranged at a distance from each other define an axis whose inclination α and an offset s can be determined in relation to the machine's axis of rotation D.

Measurement is required at at least two measuring points in order to determine the inclination α and the offset s. In particular, all measuring points are outside the reference plane E. In all exemplary embodiments, the offset s can also be determined from just the measurement at a single measuring point.

The images B represent measuring data M if the optical sensor 23 is designed as a camera 24 or matrix camera 25. The images B are provided to the control unit 30 and preferably temporarily stored in the buffer memory 32. This means that the images B can be evaluated by the control unit 30 independently of the capture speed of the camera 24 or matrix camera 25.

After recording images in the third step S13, the offset s within the reference plane E and the inclination α of the longitudinal workpiece axis L relative to the machine's axis of rotation D are determined in a fourth step S14 of the first process V1 by means of the control unit 30. The offset s in the reference plane E can be determined from the measuring data recorded in the measurement position P, depending on the distance of the measuring position P from the reference plane E.

A fifth step S15 of the first process V1 can then be used to check whether a positioning condition is fulfilled. For example, the inclination can be compared with an assigned inclination limit value and the offset s with an assigned offset limit value, and a check can be carried out to see whether the inclination α is smaller than the inclination limit value and the offset s is smaller than the offset limit value. If this is the case, the positioning condition in the fifth step S15 of the first process V1 is fulfilled and the positioning or positioning correction of the workpiece is complete (branch OK from the fifth step S15). Otherwise (branch NOK from the fifth step S15), the first process V1 is continued in a sixth step S16.

The offset s and the inclination α are then corrected in a sixth step S16 of the first process V1. This correction is shown in a simplistic form in FIGS. 3 and 4. In order to correct the offset s and the inclination α, the control unit 30 controls the position correction system 17, by means of which the workpiece carrier 13 can be inclined in relation to the machine's axis of rotation D and moved translationally. For example, the inclination α can first be reduced and ideally eliminated completely so that the longitudinal axis L of the workpiece and the machine's axis of rotation D are aligned parallel to each other. The offset s can then be reduced or eliminated with the aim of aligning the longitudinal axis L of the workpiece along the machine's axis of rotation D (FIG. 4). These corrections can also be carried out in reverse order or simultaneously. After the sixth step S16, the first process V1 is continued in the third process step S13.

In a modified embodiment of the first process V1 shown as a dashed line in FIG. 5, the camera 24 (or the optical sensor 23 in general) can be arranged not only at a single measuring position P1, P2, but also at at least two different measuring positions P1, P2 and can record images B in each of these measuring positions P1, P2. The greater distance between the measuring points O11, O12, O21, O22 can increase the accuracy when determining the inclination α and offset s.

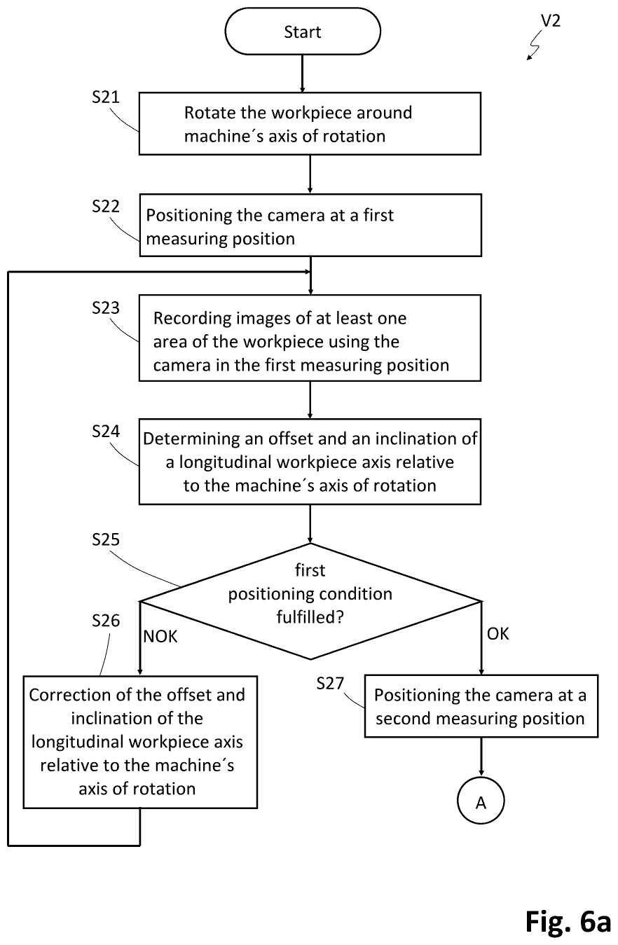

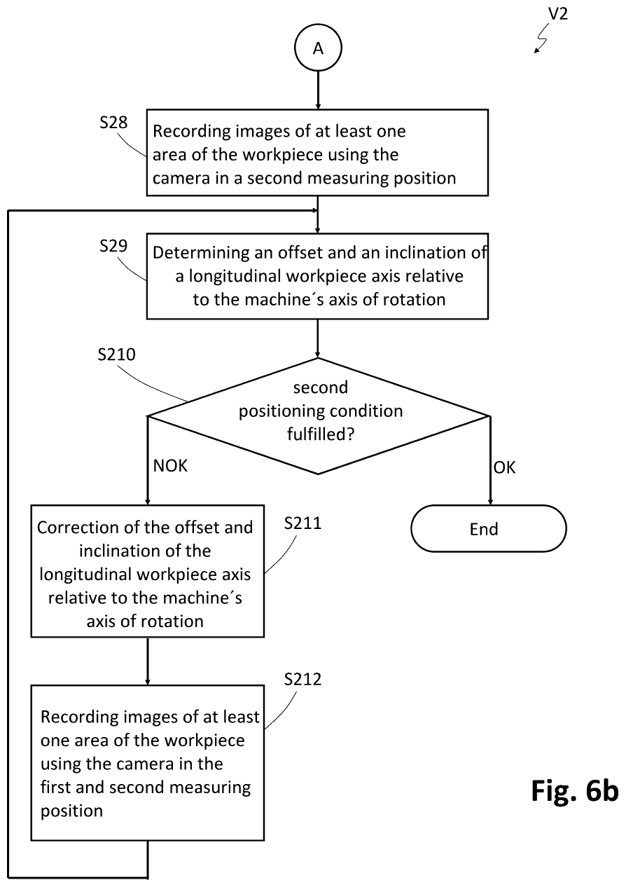

A further exemplary embodiment of the process, referred to as the second process V2, is shown in FIGS. 6a and 6b.

In the first six steps S21 to S26 of the second process V2, the process is the same as the first process V1 (steps S11 to S16), therefore reference can be made to the above description of the first process V1. In this part of the second process V2, the measuring position P is the first measuring position P1.

The fifth step S25 of the second process V2 is followed by a seventh step S27 of the second process V2 if a first positioning condition was fulfilled in the fifth step S25 (branch OK from the fifth step S25 of the second process V2). In this seventh step S27, the camera 24 or matrix camera 25 is positioned in a second measuring position P2, which differs from the first measuring position P1 in which the camera 24 was previously located. The two measuring positions P1, P2 are located at a distance from each other parallel to the machine's axis of rotation D (FIG. 2).

After the seventh process step S27, images B of a contour of the workpiece 11 are again recorded by the camera 24 or matrix camera 25 in the second measuring position P2 (eighth step S28 of the second process V2) and the offset s in the reference plane E and the inclination α of the longitudinal axis L of the workpiece relative to the machine's axis of rotation D are then determined.

A tenth step S210 of the second process V2 then checks whether a second positioning condition is fulfilled. In the same way as the first positioning condition is checked in the fifth step S25 of this second process V2, the offset s and the inclination α of the longitudinal axis L of the workpiece relative to the machine's axis of rotation D can be determined and compared with an assigned limit value in each case. The limit values of the second positioning condition can be the same as the limit values of the first positioning condition or less than the limit values of the first positioning condition in order to achieve a higher accuracy of the positioning of the workpiece 11 in the measuring machine 10.

If the second positioning condition is fulfilled, the process for positioning or correcting the position of the workpiece 11 in the measuring machine 10 ends (branch OK from the tenth step S210 of the second process V2). If the second positioning condition is not fulfilled (branch NOK from the tenth step S210 of the second process V2), the second process V2 continues in the eleventh step S211.

The determined position deviation (inclination α and offset s) is then corrected in the eleventh step S211 of the second process V2, in the same way as the sixth step S16 of the first process V1 and the sixth step S26 in the second process V2. In a subsequent twelfth process step, the camera 14 is positioned successively in the second measuring position P2 and the first measuring position P1 (or alternatively the other way round) and images B are recorded in each measuring position P2, P1. The second process V2 then continues in the ninth process step V29.

The second process V2 is, so to speak, a two-step process compared to the single-step first process V1. Initially, the workpiece 11 is positioned less accurately in the measuring machine 10, as the camera 24 only takes images B at a first measuring position P1. The workpiece 11 is then positioned more accurately in the measuring machine 10 in a further part of the process, as the camera 24 then records images B at two measuring positions P1 and P2, located at a distance from one another, in such a way that the actual position and alignment of the longitudinal axis L of the workpiece in the machine coordinate system Km can be determined more precisely. It is also advantageous to use the second positioning condition to set stricter specifications for the permissible position deviation of the longitudinal axis L of the workpiece in relation to the machine's axis of rotation D.

For example, the first process V1 and the first part of the second process V2 can be set up to achieve rapid positioning of the workpiece 11. In this case, the optical sensor 23 and, for example, the camera 24 or matrix camera 25 remain in a single measuring position P, e.g. in the first measuring position P1. The offset s and the inclination α can be determined by taking measurements at several measuring points O11 and O12 in the first measuring position P1. The distance between the measuring points O11, O12 or O21, O22 in a single measuring position P is limited and, in the exemplary embodiment, depends on the size of the camera sensor, i.e. in particular the number of pixel elements in the direction parallel to the machine's axis of rotation D.

In order to achieve greater accuracy (for example in the second part of the second process V2), the optical sensor 23 or the camera 24 can additionally measure in a second measuring position P2, which is arranged at a distance from the first measuring position P1 towards the machine's axis of rotation D. This makes it possible to determine the offset s and the inclination α of the longitudinal axis L of the workpiece in relation to the machine's axis of rotation D more precisely.

In all exemplary embodiments, measuring data M from at least two measuring points can be recorded in at least one measuring position P to check the relevant positioning condition, and the resulting position deviation (offset s and inclination α) between the longitudinal axis L of the workpiece and the machine's axis of rotation D can be compared with predefined limit values. For example, in the second process V2, after a correction of the offset s and the inclination α in the tenth step S210 of the second process V2, measuring data M (here: images B) can be recorded again both in the first measuring position P1 and in the second measuring position P2, and then the remaining offset s and the remaining inclination α can be determined and compared with the respective assigned limit values of the second positioning condition.

For example, the first positioning condition is fulfilled if the following is true:

$$α < α {1}_{lim} \qquad ( 1 )$$

$$s < s {1}_{lim} \qquad ( 2 )$$

The second positioning condition is fulfilled if the following is true:

$$α < {α2}_{lim} \leq {α1}_{lim} \qquad ( 3 )$$

$$s < s {2}_{lim} \leq s {1}_{lim} \qquad ( 4 )$$

In equations (1) to (4), α1ₗᵢₘ is a first angle of inclination limit value, α2ₗᵢₘ is a second angle of inclination limit value, S1ₗᵢₘ is a first offset limit value and S2ₗᵢₘ is a second offset limit value.

In all exemplary embodiments, the workpiece carrier 13, and thus the workpiece 11, is rotated continuously (preferably at a constant speed) around the machine's axis of rotation D without stopping, during positioning or correcting the position of the workpiece 11 in the measuring machine 10 and in particular during the recording of the images B at the measuring positions P1, P2 and the activation of the position correction system 17. Stopping and re-acceleration of the rotating drive 22 is avoided. In particular, the rotational movement caused by the rotating drive 22 can only be stopped when the first process V1 or the second process V2 has been completed, i.e. when the desired positioning of the workpiece 11 in the measuring machine 10 has been achieved.

Because the optical sensor 23—in particular camera 24 or matrix camera 25—measures a contour of the workpiece 11 either exclusively in a single measuring position P or in several measuring positions P1, P2, very fast positioning of the workpiece 11 or—if necessary or desired—very precise positioning of the workpiece 11 in the measuring machine 10 can be achieved, depending on the application. Positioning the optical sensor 23 in a single measuring position P (e.g. first measuring position P1) or two different measuring positions P1, P2 is sufficient.

The invention relates to a measuring machine 10 and a process for positioning a workpiece 11 in the measuring machine 10. For this purpose, a workpiece carrier 13 holding the workpiece 11 is driven around a machine's axis of rotation D and an optical sensor 23, preferably designed as a camera 24 or matrix camera 25, is positioned in a measuring position parallel to the machine's axis of rotation D. In this measuring position, measuring data M, for example images B, are recorded on the workpiece 11 and made available to a control unit 30. In the control unit 30, an offset s and/or an inclination α of a longitudinal axis L of the workpiece relative to the machine's axis of rotation D is determined from the measuring data M of at least two measuring points on the workpiece 11 and then reduced or eliminated by activating a position correction system of the measuring machine 10 in such a way that a specified positioning condition is fulfilled. The position correction system 17 is set up to tilt and/or translationally move the workpiece carrier 13 relative to the machine's axis of rotation D.

### LIST OF REFERENCE SYMBOLS

10 Measuring machine
11 Workpiece
12 Machine base
13 Workpiece carrier
14 Clamping device
17 Position correction system
18 Linear drive system
18x First linear drive
18y Second linear drive
19 Tilting drive system
19x First tilting drive
19y Second tilting drive
22 Rotating drive
23 Optical sensor
24 Camera
25 Matrix camera
26 Sensor positioning device
27 Column
28 Slide
29 Lighting device
30 Control unit
31 Computing device
32 Buffer memory
α Inclination
B Image
D Machine's axis of rotation
E Reference plane
Km Machine coordinate system
Kw Position correction coordinate system
L Longitudinal axis of workpiece
M Measuring data
O Measuring point
O11 First measuring point in the first measuring position
O12 Second measuring point in the first measuring position
O21 First measuring point in the second measuring position
O22 Second measuring point in the second measuring position
P Measuring position
P1 First measuring position
P2 Second measuring position
S Offset
S11 First step of the first process
S12 Second step of the first process
S13 Third step of the first process
S14 Fourth step of the first process
S15 Fifth step of the first process
S16 Sixth step of the first process
S21 First step of the second process
S22 Second step of the second process
S23 Third step of the second process
S24 Fourth step of the second process
S25 Fifth step of the second process
S26 Sixth step of the second process
S27 Seventh step of the second process
S28 Eighth step of the second process
S29 Ninth step of the second process
S210 Tenth step of the second process
S211 Eleventh step of the second process
S212 Twelfth step of the second process
V1 First process
V2 Second process
xm First coordinate axis of a machine coordinate system
XW First coordinate axis of a position correction coordinate system
ym Second coordinate axis of a machine coordinate system
yw Second coordinate axis of a position correction coordinate system
zm Third coordinate axis of a machine coordinate system
zw Third coordinate axis of a position correction coordinate system

1. A measuring machine (10) for measuring a workpiece (11), comprising:
a workpiece carrier (13) for supporting the workpiece (11);
a rotating drive (22) for rotating the workpiece carrier (13) around an axis of rotation (D);
an optical sensor (23) configured to record measuring data (M) on a contour of the workpiece (11);
a sensor positioning device (26) configured to position the optical sensor (23) parallel to the axis of rotation (D) in at least one measuring position (P);
a position correction system (17) configured to tilt and/or translationally move the workpiece carrier (13) relative to the axis of rotation (D); and
a control unit (30) configured to control the rotating drive (22), the optical sensor (23) and the sensor positioning device (26) such that during rotation of the workpiece (11) around the axis of rotation (D), the measuring data (M) is recorded by the optical sensor (23) in the at least one measuring position (P), wherein the measuring data (M) describes an offset(s) and/or an inclination (α) of a longitudinal axis (L) of the workpiece relative to the axis of rotation (D), and wherein the control unit (30) is configured to control the position correction system (17) during rotation of the workpiece (11) around the axis of rotation (D), such that the offset(s) and/or the inclination (α) fulfill(s) a predetermined positioning condition.

2. The measuring machine according to claim 1, wherein the optical sensor (23) is a camera (24).

3. The measuring machine according to claim 2, wherein the camera (24) is a line scanning or matrix camera (25).

4. The measuring machine according to claim 2, wherein the camera (24) is configured to record at least one image (B) of a contour of at least one section of the workpiece (11) as the measuring data (M).

5. The measuring machine according to claim 1, further comprising a buffer memory (32) which is communicatively connected to the optical sensor (23) and the control unit (30) and which is configured to temporarily store the measuring data (M) provided by the optical sensor (23).

6. The measuring machine according to claim 1, wherein the control unit (30) is configured to cause the optical sensor (23) to record and provide the measuring data (M), and wherein the control unit (30) is further configured to compare the provided measuring data (M) with reference data to determine whether the predetermined positioning condition is fulfilled.

7. The measuring machine according to claim 6, wherein the control unit (30) is configured to cause the optical sensor (23) to record and provide measuring data (M) at a single measuring position (P).

8. The measuring machine according to claim 6, wherein the control unit (30) is configured to cause the optical sensor (23) to record and provide measuring data (M) at at least two different measuring positions (P1, P2).

9. The measuring machine according to claim 8, wherein the control unit (30) is configured to:
cause the sensor positioning device (26) to position the optical sensor (23) in a first measuring position (P1) of the at least two different measuring positions (P1, P2);
cause the optical sensor (23) to record and provide measuring data (M) at the first measuring position (P1);
compare the measuring data (M) recorded and provided at the first measuring position (P1) with first reference data (α1ₗᵢₘ, s1ₗᵢₘ) to determine whether a first positioning condition (R1) is fulfilled;
cause the sensor positioning device (26) to position the optical sensor (23) at a second measuring position (P2) of the at least two different measuring positions (P1, P2);
cause the optical sensor (23) to record and provide measuring data (M) at the second measuring position (P2); and
compare the measuring data (M) recorded and provided at the second measuring position (P2) with second reference data (α2ₗᵢₘ, s2ₗᵢₘ) to determine whether a second positioning condition (R2) is fulfilled.

10. The measuring machine according to claim 9, wherein positioning of the optical sensor (23) in the second measuring position (P2) only takes place when the first positioning condition (R1) is fulfilled.

11. The measuring machine according to claim 9, wherein the second reference data is different from the first reference data.

12. The measuring machine according to claim 11, wherein the second reference data (α2ₗᵢₘ, s2ₗᵢₘ) defines a smaller offset(s) and/or a smaller inclination (α) of the longitudinal axis (L) of the workpiece relative to the axis of rotation (D) than the first reference data (α1ₗᵢₘ, s1ₗᵢₘ).

13. The measuring machine according to claim 1, wherein a communication connection between the control unit (30) and the position correction system (17) is wireless and/or wherein a power supply connection to the position correction system (17) is wireless.

14. The measuring machine according to claim 1, wherein a reference plane (E) is defined orthogonal to the axis of rotation (D), wherein the offset(s) and/or the inclination (α) are determined in the reference plane (E).

15. The measuring machine according to claim 14, wherein the reference plane (E) is defined outside an area in which the workpiece (11) is positioned in the measuring machine (10).

16. A process (V1, V2) for positioning a workpiece (11) in a measuring machine (10) prior to measuring a form and/or a contour of the workpiece (11), the process (V1, V2) comprising:
placing the workpiece (11) on a workpiece carrier (13);
rotating the workpiece carrier (13) around an axis of rotation (D);
contactlessly recording measuring data (M) on the contour of the workpiece (11) by an optical sensor (23) at a measuring position (P1, P2) of the optical sensor (23) along the axis of rotation (D) during rotation of the workpiece (11) around the axis of rotation (D), wherein the measuring data (M) describes an offset(s) and/or an inclination (α) of a longitudinal axis (L) of the workpiece relative to the axis of rotation (D); and
controlling a position correction system (17) during the rotation of the workpiece (11) around the axis of rotation (D) until the offset(s) and/or the inclination (a) fulfill(s) a specified positioning condition (R1, R2), wherein the position correction system (17) is configured to incline and/or translationally move the workpiece carrier (13) relative to the axis of rotation (D).
